(19) United States
(12) Patent Application Publication
(10) Pub. No.: US 2014/0291540 A1
(43) Pub. Date: Oct. 2, 2014

(54) RADIATION GENERATING APPARATUS AND RADIOGRAPHIC IMAGING SYSTEM

(71) Applicant: CANON KABUSHIKI KAISHA, TOKYO (JP)

(72) Inventor: Shichihei Sakuragi, Tokyo (JP)

(73) Assignee: CANON KABUSHIKI KAISHA, TOKYO (JP)

(21) Appl. No.: 14/226,657

(22) Filed: Mar. 26, 2014

(30) Foreign Application Priority Data
Mar. 29, 2013 (JP) 2013-073015

(51) Int. Cl. G21K 5/10

(52) U.S. Cl. CPC G21K 5/10
USPC 250/393; 250/493.1

(57) ABSTRACT

A radiation generating apparatus includes a support structure that supports a radiation generating unit that generates radiation; and a base frame that supports the support structure and includes a plurality of leg portions configured to be arranged in a predetermined manner in accordance with an imaging state or storage state of the radiation generating apparatus.

### BACKGROUND OF THE INVENTION

1. Field of the Invention

The present invention relates to a radiation generating apparatus and a radiographic imaging system each including a radiation generating unit that irradiates an object with radiation.

2. Description of the Related Art

Some radiographic imaging systems recently available are portable. When a portable radiographic system is used to irradiate an object, the radiation generating unit is positioned in accordance with a target position of the object.

A radiographic system has been developed that has a unit formed by integrating, via a holding arm, a radiation generating unit and a detecting device that detects radiation emitted from the radiation generating unit (Japanese Patent Application Laid-Open No. 2012-70835). In another radiographic system, a supporting portion that supports a radiation generating unit is fixed to a bed (Japanese Patent Application Laid-Open No. 2011-136028).

In the radiographic system disclosed in Japanese Patent Application Laid-Open No. 2012-70835, however, the detecting device needs to be positionally adjusted after the detecting device is positioned on the back of the object, which causes discomfort to the object. Thus, various measures to reduce the load on the object have been demanded.

In the case of the radiographic system disclosed in Japanese Patent Application Laid-Open No. 2011-136028, the supporting portion that supports the radiation generating unit is compatible with only a specific type of beds. This limits the application of the radiographic system to only the specific type of beds for which the system has been designed. Therefore, various measures of improvement have been demanded.

### SUMMARY OF THE INVENTION

Embodiments of present invention disclose a radiation generating apparatus and a radiographic imaging system that are portable and that can easily position a radiation generating unit in accordance with a target position of any object to be imaged.

A radiation generating apparatus and a radiographic system according to an embodiment of the invention each include a support structure, which supports a radiation generating unit that generates radiation, and a base frame, which supports the support structure and includes a plurality of leg portions configured to be arranged in a predetermined manner in accordance with an imaging state or storage state of the radiation generating apparatus.

Further features of the present invention will become apparent from the following description of exemplary embodiments with reference to the attached drawings.

### BRIEF DESCRIPTION OF THE DRAWINGS

FIG. 1 illustrates an exemplary configuration of a radiation generating apparatus according to an embodiment of the present invention.

FIG. 2 illustrates a base frame of the radiation generating apparatus according to an embodiment of the present invention.

FIG. 3 illustrates the radiation generating apparatus according to an embodiment of the present invention in a storage position.

FIGS. 4A and 4B illustrate the radiation generating apparatus according to an embodiment of the present invention in the form of being divided into parts.

FIG. 5 illustrates a rotation portion of the radiation generating apparatus according to an embodiment of the invention.

FIG. 6 illustrates the radiation generating apparatus according to an embodiment of the invention in one installation form.

FIG. 7 illustrates the radiation generating apparatus according to an embodiment of the invention in one installation form for imaging.

FIG. 8 illustrates the radiation generating apparatus according to an embodiment of the invention in one installation form for imaging.

FIG. 9 illustrates the radiation generating apparatus according to an embodiment of the invention in one installation form for imaging.

FIGS. 10A and 10B illustrate a radiation generating apparatus according to a second embodiment of the invention.

FIGS. 11A and 11B illustrate a radiation generating apparatus according to a third embodiment of the invention.

### DESCRIPTION OF THE EMBODIMENTS

Referring now to the appended drawings, embodiments of the present invention will be described.

### First Embodiment

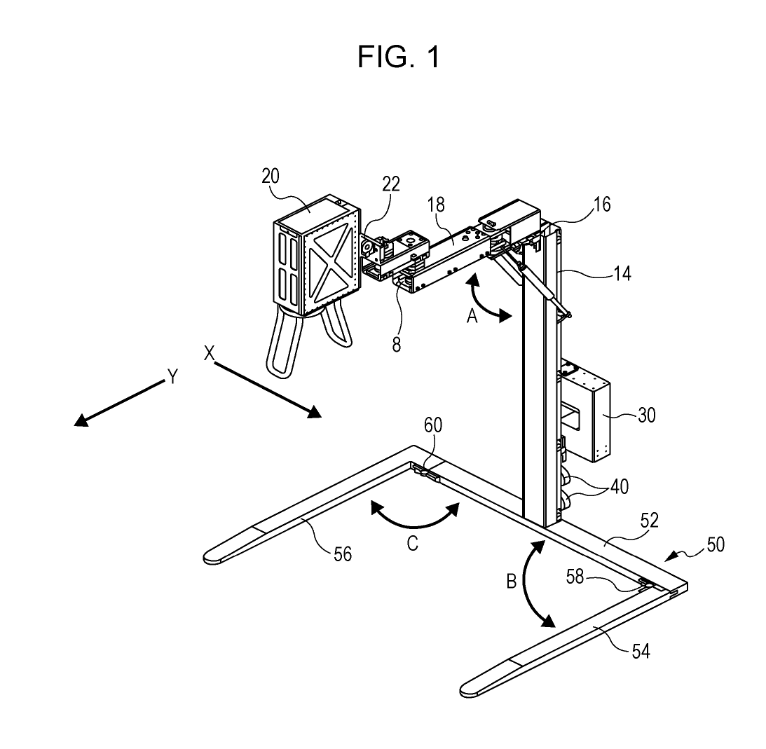

FIG. 1 illustrates the configuration of a radiation generating apparatus according to the first embodiment. FIG. 1 schematically illustrates the radiation generating apparatus during imaging.

The radiation generating apparatus includes a base frame 50 placed on the floor, a pillar 14 vertically protruding from the base frame 50, an arm 18 rotatably coupled to the pillar 14, and a radiation generating unit 20 rotatably coupled to the arm 18 and configured to generate radiation. FIG. 1 illustrates a radiation generating apparatus that does not include a display device for displaying images in order to minimize the size of the radiation generating apparatus. The pillar 14 and the arm 18 may also be expressed as a support structure that supports the radiation generating unit 20 that generates radiation.

As illustrated in FIG. 1, a power supply unit 30 for supplying power to the radiation generating unit 20 is attached to the pillar 14. Specifically, the power supply unit 30 is disposed at a lower portion of the pillar 14 so as to be integrated with the pillar 14. The power supply unit 30 is disposed on the opposite side (back side in FIG. 1) to the side to which the radiation generating unit 20 is attached (front side in FIG. 1). The power supply unit 30 is attached to the side of the pillar 14 at which the arm 18 and the radiation generating unit 20 do not interfere with the power supply unit 30 when the arm 18 is folded. Since the power supply unit 30 is a relatively heavy component, when the power supply unit 30 is disposed at a lower portion (portion near the floor) of the pillar 14, the radiation generating apparatus can be finely balanced with a center of gravity substantially low. Although not illustrated, a power cable for supplying power from the power supply unit 30 to the radiation generating unit 20 may be passed through the pillar 14 and the arm 18.

Radiation generating apparatus having a high-powered radiation generating unit 20 are usually demanded in accordance with a demand of high quality images. However, as a radiation generating unit 20 has higher power, the radiation generating unit 20 becomes heavier. In radiation generating apparatuses for which portability and operability during assembly are regarded as important, a weight reduction and an improvement in image quality of the radiation generating unit 20 are incompatible with each other. To address this situation, some radiation generating apparatuses reduce the weight of the entire body by reducing the weight of the support structure (the pillar 14 and the arm 18) of the radiation generating unit 20. If, however, the weight of the support structure is too small relative to the weight of the radiation generating unit 20, the device may become unbalanced and fall. To address this inconvenience, the power supply unit 30 is attached to the pillar 14 on the opposite side to the radiation generating unit 20, whereby the device can be appropriately balanced.

By thus connecting the power supply unit 30 loaded with batteries to the radiation generating unit 20 so that the radiation generating apparatus is operable in a low-power environment, the radiation generating unit 20 can perform imaging in an environment without access to power supply. Here, the device can be easily balanced by utilizing the weight of the radiation generating unit 20 and the weight of the power supply unit 30.

The arm 18 is coupled to the radiation generating unit 20 at one end and to the pillar 14 at the other end. The arm 18 supports the radiation generating unit 20 and has a predetermined length. As illustrated in FIG. 1, the arm 18 may have an extension-contraction structure, which allows the arm 18 to extend or contract in the longitudinal direction, or an articulated structure, which allows the arm 18 to bend in various directions and which can also serve as a rotation mechanism that allows the arm 18 to rotate. By extending the arm 18 in a predetermined direction, the radiation generating unit 20 can be thrust toward the object.

The arm 18 does not have to be straight, as illustrated in FIG. 1, and may be curved. The arm 18 may be made up of a group of multiple components, for example, a group of stick members, a group of tubular members, or a group of telescopic linear members (network structure). In other words, the arm 18 may be in any form provided that the arm 18 can support the radiation generating unit 20. The articulated structure of the arm 18 is formed by joining two sections of the arm 18 at a substantially center portion of the arm 18 via a joint portion 8. Since the arm 18 is rotatable around the joint portion 8, the horizontal position of the radiation generating unit 20 can be adjusted. The joint portion 8 allows smooth positioning of the radiation generating unit 20, thereby improving the operation efficiency of the radiation generating apparatus.

A torque hinge may be disposed inside the joint portion 8. The horizontality of the contact surface on which the radiation generating apparatus is installed, such as on a mattress for home care or at the site of a disaster, is not always guaranteed. In such a case, the joint portion 8 may rotate due to the weight of the radiation generating unit 20 and the arm 18 may fail to be fixed to an appropriate position. To prevent the joint portion 8 from moving against the intention of an operator, the joint portion 8 has to have an immobilizing mechanism. By providing a torque hinge as an example of the immobilizing mechanism, the joint portion 8 has a higher resistance and thus can be prevented from moving against the intention of the operator. Here, the torque exerted by the torque hinge is smaller than the torque exerted by the operator to adjust the position of the radiation generating unit 20.

The arm 18 can rotate around an upper end of the pillar 14. Specifically, as illustrated in FIG. 1, the pillar 14 includes an arm hinge portion 16 to allow the arm 18 to rotate in a predetermined direction (A direction). The arm 18 is rotatable in the predetermined direction (A direction) within a range of approximately 180°. The arm 18 can bend toward the side opposite to the side to which the power supply unit 30 is attached.

The arm hinge portion 16 couples the arm 18 and the pillar 14 together and allows the arm 18 to be folded toward and unfolded away from the pillar 14. When the arm 18 is folded using the arm hinge portion 16 as an axis, the arm 18 becomes substantially parallel to the pillar 14.

When the arm hinge portion 16 allows the arm 18 to rotate in a predetermined direction (A direction), the arm hinge 16 can change the position of the arm 18 from a vertically-extending or horizontally-extending position, as illustrated in FIG. 1, to a storage position at which the arm 18 is retracted together with the radiation generating unit 20. In the vertically-extending or horizontally-extending position illustrated in FIG. 1, the arm 18 thrusts the radiation generating unit 20 toward the object. In the storage position of the arm 18 in which the arm 18 is retracted together with the radiation generating unit 20, the arm 18 is folded so as to become substantially parallel to the pillar 14, that is, the radiation generating unit 20 is positioned near the ground. The storage position of the arm 18 in which the arm 18 is retracted together with the radiation generating unit 20 will be described in detail below.

The pillar 14 does not have to be straight, as illustrated in FIG. 1, and may be curved. The pillar 14 may be made up of a group of multiple components, for example, a group of stick members, a group of tube members, or a group of line members (network structure). In other words, the pillar 14 may be in any form provided that the pillar 14 can rotatably support the arm 18.

Between the radiation generating unit 20 and the arm 18, a rotation portion 22 that can rotate the radiation generating unit 20 is disposed. Rotating the radiation generating unit 20 allows the radiation generating unit 20 to be appropriately positioned with respect to the object and radiation to be emitted in a desired direction.

The base frame 50 is a C-shaped or U-shaped structure. The base frame 50 is used to keep the radiation generating apparatus disposed on a flat surface in balance. The base frame 50 can be installed at a position away from a position beneath (vertically) the radiation generating unit 20. A detecting device is disposed beneath (vertically) the radiation generating unit 20. In other words, a detecting device is disposed in a region in which the base frame 50 is not disposed.

To maintain the radiation generating apparatus disposed on a flat surface in balance, the base frame 50 includes a plurality of leg portions 52, 54, and 56. The plurality of leg portions 52, 54, and 56 are in contact with the floor (or a bed) otherwise referred herein as a flat surface. The plurality of leg portions 52, 54, and 56 are arranged on the floor so that the radiation generating apparatus is balanced. The base frame 50 can be formed into a C shape or a U shape by changing the positions of the leg portions 52, 54, and 56. During imaging, the base frame 50 is C-shaped or U-shaped by arranging the leg portions in a predetermined manner, as illustrated in FIG. 1.

The base frame 50 includes a first (or main) leg portion 52 coupled to the pillar 14, a second leg portion 54 coupled to the first leg portion 52, and a third leg portion 56 coupled to the first leg portion 52. The second leg portion 54 and the third leg portion 56 have substantially the same length.

Herein, the longitudinal direction of the first leg portion 52 is taken as the X direction and the direction perpendicular to the longitudinal direction of the first leg portion 52 is taken as the Y direction. As illustrated in FIG. 1, the second leg portion 54 and the third leg portion 56 are disposed so as to be perpendicular to the first leg portion 52 during imaging. Accordingly, the second leg portion 54 is parallel to the third leg portion 56. The second leg portion 54 and the third leg portion 56 are disposed so as to extend in the Y direction, perpendicular to the longitudinal direction of the first leg portion 52, or in the direction in which the radiation generating unit 20 is thrust. In terms of the X direction, which is the longitudinal direction of the first leg portion 52, the radiation generating unit 20 is disposed above the base frame 50 substantially in the center between the second leg portion 54 and the third leg portion 56.

The second leg portion 54 is tapered or has a slope at an end section thereof so that the thickness of the leg portion gradually decreases toward the end. Here, the end section of the second leg portion 54 is located on the opposite end of the second leg portion 54 to the end coupled to the first leg portion 52. The bottom surface of the second leg portion 54 is flat and in contact with the floor.

The height of the top surface of the second leg portion 54 decreases toward the end. Since the second leg portion 54 has the tapered end section, the thickness of the second leg portion 54 at the end section thereof can be reduced.

Similarly, the third leg portion 56 is tapered or has a slope at an end section thereof so that the thickness of the leg portion gradually decreases toward the end. Here, the end section of the third leg portion 56 is on the opposite end of the third leg portion 56 to the end coupled to the first leg portion 52. The bottom surface of the third leg portion 56 is flat and in contact with the floor. The height of the top surface of the third leg portion 56 decreases toward the end. Since the third leg portion 56 has the tapered end section, the thickness of the third leg portion 56 at the end section thereof can be reduced.

The tapered end sections of the second leg portion 54 and the third leg portion 56 have substantially the same length. The length of the tapered section may be appropriately determined (within the range of, for example, 10 cm to 50 cm).

The base frame 50 includes a plurality of joints 58 and 60 so that the leg portions 54 and 56 of the base frame 50 can be folded. Specifically, the joint 58 can adjust the angle between the first leg portion 52 and the second leg portion 54. The joint 58 allows the second leg portion 54 to be folded and to be rotated in the B direction. The joint 58 is movable within a range of approximately 90°, so that the joint 58 can change the longitudinal direction of the second leg portion 54 from the Y direction to the X direction. In this manner, the second leg portion 54 is foldable at the joint 58.

Similarly, the joint 60 can adjust the angle between the first leg portion 52 and the third leg portion 56.

The joint 60 allows the third leg portion 56 to be folded and to be rotated in the C direction. The joint 60 is movable within a range of approximately 90°, so that the joint 60 can change the longitudinal direction of the third leg portion 56 from the Y direction to the X direction. In this manner, the third leg portion 56 is foldable at the joint 60.

The rotation axis of the joint 58 that allows the second leg portion 54 to rotate and the rotation axis of the joint 60 that allows the third leg portion 56 to rotate are parallel to each other. When the second leg portion 54 and the third leg portion 56 are folded, the second leg portion 54 and the third leg portion 56 become parallel to the first leg portion 52.

Now, a difference between the shape of the second leg portion 54 and the shape of the third leg portion 56 is described. The shape of the second leg portion 54 at a portion near the joint 58 is slightly different from the shape of the third leg portion 56 at a portion near the joint 60. The second leg portion 54 is straight, while the third leg portion 56 is L-shaped. These portions are so shaped that the second leg portion 54 can be covered by the third leg portion 56 after the second leg portion 54 and the third leg portion 56 are folded for storage of the base frame 50. The connection end portion of the L-shaped third leg portion 56 is wider than the connection end portion of the second leg portion 54. At the time of storage, the straight second leg portion 54 is folded first and then the L-shaped third leg portion 56 is folded.

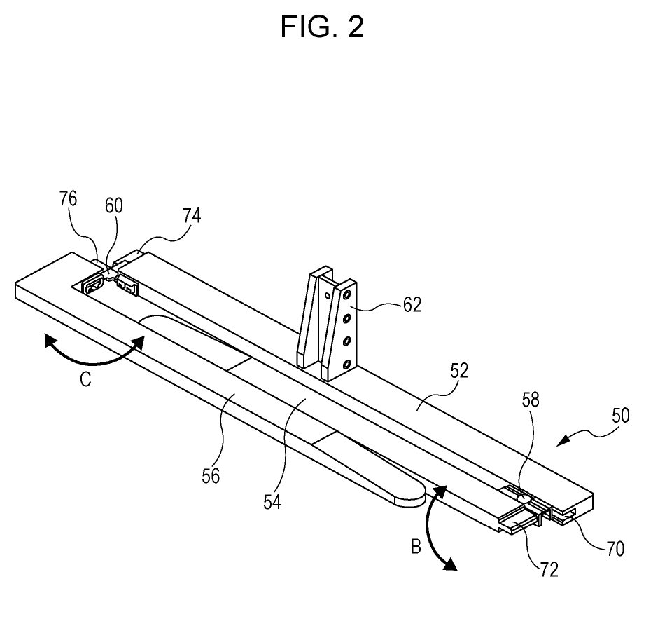

FIG. 2 illustrates the base frame 50 in the storage position. As illustrated in FIG. 2, when the second leg portion 54 and the third leg portion 56 are folded, the second leg portion 54 and the third leg portion 56 become parallel to the first leg portion 52 while the third leg portion 56 covers the second leg portion 54. Specifically, the angle between the first leg portion 52 and the second leg portion 54 during imaging is larger than the angle between the first leg portion 52 and the second leg portion 54 during storage and the angle between the first leg portion 52 and the third leg portion 56 during imaging is larger than the angle between the first leg portion 52 and the third leg portion 56 during storage.

In this manner, the base frame 50 can be compactly stored. Thus, an operator can easily carry the base frame 50.

As illustrated in FIG. 2, the base frame 50 also includes a pair of a recess 70 and a protrusion 72 for fitting the second leg portion 54 into the first leg portion 52 and a pair of a recess 76 and a protrusion 74 for fitting the first leg portion 52 into the third leg portion 56.

Specifically, the first leg portion 52 has the recess 70 at one end and the protrusion 74 at the other end. The second leg portion 54 has the protrusion 72. The protrusion 72 of the second leg portion 54 is on the opposite end to the tapered end section. The protrusion 72 is sized so as to be snuggly fitted into the recess 70 of the first leg portion 52. When the second leg portion 54 is rotated around the joint 58, the protrusion 72 of the second leg portion 54 is fitted into the recess 70 of the first leg portion 52, as illustrated in FIG. 1, and thus the second leg portion 54 is fixed to the first leg portion 52.

The third leg portion 56 has the recess 76. The recess 76 of the third leg portion 56 is on the opposite end to the tapered end section. The recess 76 is so sized that the protrusion 74 of the first leg portion 52 can be snuggly fitted into the recess 76. When the third leg portion 56 is rotated around the joint 60, the protrusion 74 of the first leg portion 52 is fitted into the recess 76 of the third leg portion 56, as illustrated in FIG. 1, and thus the third leg portion 56 is fixed to the first leg portion 52.

During imaging, the second leg portion 54 and the third leg portion 56 are disposed perpendicular to the first leg portion 52, as illustrated in FIG. 1. The pair of the recess 70 and the protrusion 72 and the pair of the recess 76 and the protrusion 74 allows the second leg portion 54 and the third leg portion 56 to be fixed to the first leg portion 52.

As illustrated in FIG. 2, the base frame 50 includes a coupling portion so as to be removably coupled with the pillar 14. Specifically, the first leg portion 52 has a coupling portion 62 that is coupled with the pillar 14. The coupling portion 62 protrudes upward from the first leg portion 52. The pillar 14, which is a hollow member, and the first leg portion 52 are coupled together, as illustrated in FIG. 1, in such a manner that the pillar 14 contains the coupling portion 62 that protrudes upward. The coupling portion 62 may have a tapered top portion for being easily coupled with the pillar 14.

After the pillar 14 is placed over the base frame 50, the operator fixes the coupling portion 62 of the first leg portion 52 to the pillar 14 via a fixing portion 40.

The fixing portion 40 is, for example, a screw member (male screw). Although not illustrated, a hole sized so as to allow the fixing portion 40 to pass therethrough is formed on a side of the pillar 14. In addition, the coupling portion 62 of the first leg portion 52 has such a structure as to allow the fixing portion 40 to be fixed thereto. The coupling portion 62 of the first leg portion 52 includes, for example, a female screw that can accept the screw member. In this manner, the base frame 50 can be coupled with and fixed to the pillar 14 via the fixing portion 40.

When the operator unfastens the fixing portion 40, the pillar 14 can be detached from the base frame 50. Thus, the operator can separately carry the base frame 50 and the rest of the radiation generating apparatus.

The pillar 14 may includes a handle for the operator to grip to carry the radiation generating apparatus at, for example, the upper end of the pillar 14. When the base frame 50 is detached from the rest of the radiation generating apparatus (the radiation generating unit 20, the arm 18, the pillar 14, and the power supply unit 30), the operator can carry the portion of the radiation generating apparatus excluding the base frame 50 by gripping and holding the handle.

The base frame 50 including multiple leg portions, that is, the first leg portion 52, the second leg portion 54, and the third leg portion 56 has been exemplarily described. However, a form of a base frame 50 made up of a single curved member without a joint can be included in the concept of a base frame including multiple leg portions.

The concept of the plurality of leg portions of the base frame 50 includes at least two leg portions. For example, the plurality of leg portions may be three leg portions, four leg portions, or five leg portions. The plurality of leg portions of the base frame 50 do not have to be straight and may be curved.

The plurality of leg portions of the base frame 50 may be made up of a group of multiple components, for example, a group of stick members, a group of tube members, or a group of line members (network structure).

In other words, the plurality of leg portions of the base frame 50 may be in any of the above-described forms provided that the base frame 50 can support the support structure (pillar 14) that supports the radiation generating unit that emits radiation.

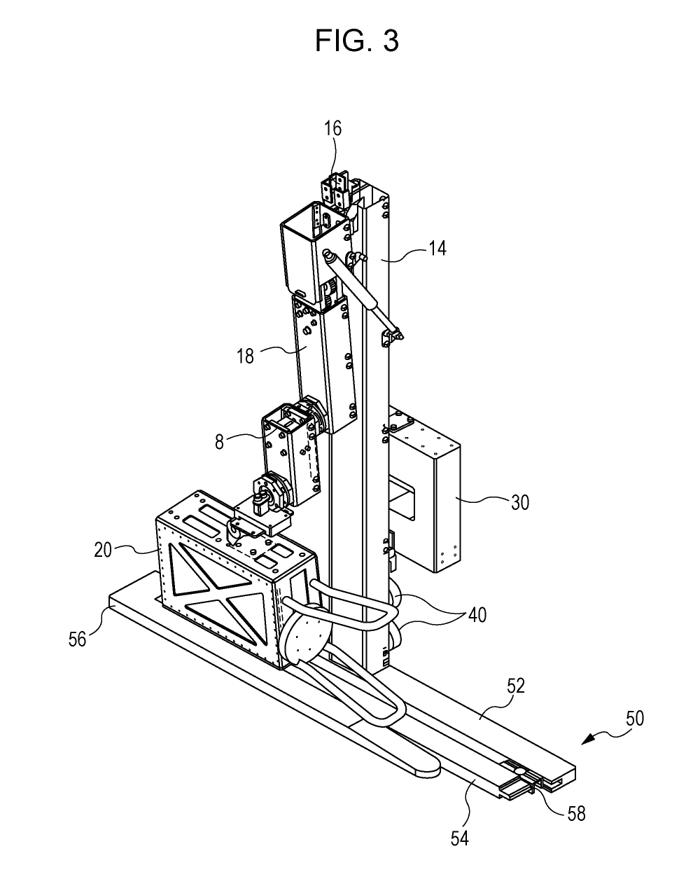

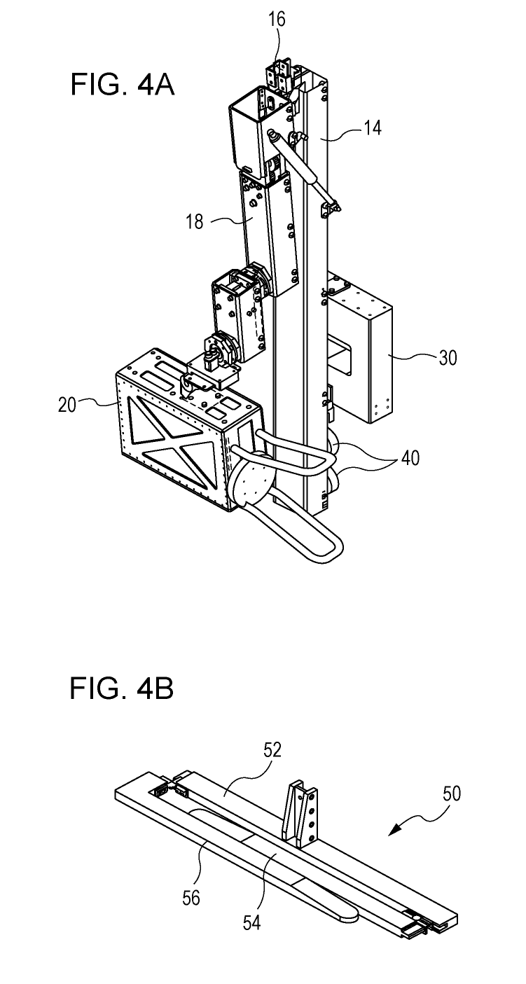

Referring now to the FIGS. 3, 4A, and 4B, the storage form and the division form of the radiation generating apparatus will be described. FIG. 3 illustrates the radiation generating apparatus in the storage form in which the arm 18 and the base frame 50 are folded and retracted. Specifically, when the arm 18 is folded, the arm 18 becomes substantially parallel to the pillar 14 and the arm 18 is retracted together with the radiation generating unit 20. In addition, when the base frame 50 is folded, the second leg portion 54 and the third leg portion 56 are folded over the first leg portion 52, so that the base frame 50 is retracted.

The arm 18 and the pillar 14 are relatively long components compared to the other components of the radiation generating apparatus. By disposing the arm 18 and the pillar 14 above the base frame 50, the radiation generating apparatus can be finely balanced. The radiation generating unit 20 and the power supply unit 30 are relatively heavy components compared to the other components of the radiation generating apparatus. By disposing, when the arm 18 is retracted together with the radiation generating unit 20, the radiation generating unit 20 and the power supply unit 30 at portions near the floor (near the base frame 50), the radiation generating apparatus can be finely balanced.

In order to detach the base frame 50 and the rest of the radiation generating apparatus from each other to carry them, the operator unfastens the fixing portion 40 used to fix the coupling portion 62 of the first leg portion 52 and the pillar 14 together. Thus, the fixing portion 40 is no longer used to fix the base frame 50 and the pillar 14 together and the base frame 50 and the pillar 14 are detachable from each other. The radiation generating apparatus is divided into the base frame 50 illustrated in FIG. 4B and the rest of the radiation generating apparatus illustrated in FIG. 4A (the radiation generating unit 20, the arm 18, the pillar 14, and the power supply unit 30). The operator can thus carry the radiation generating unit 20 and the power supply unit 30 by holding the handle of the pillar 14.

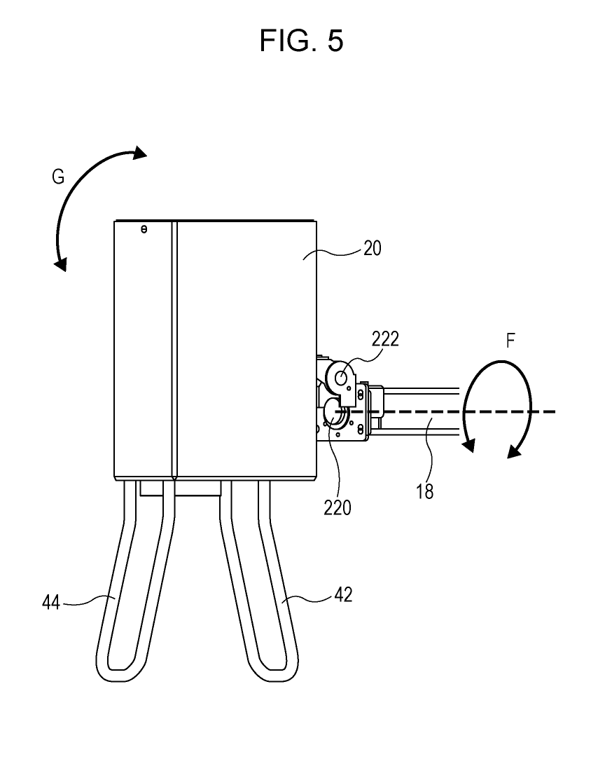

FIG. 5 specifically illustrates the rotation portion 22 that rotates the radiation generating unit 20. The rotation portion 22 includes a swivel hinge 220 and a tilt hinge 222. The swivel hinge 220 allows the radiation generating unit 20 to rotate around the axis parallel to the longitudinal direction of the arm 18. The tilt hinge 222 allows the radiation generating unit 20 to rotate around the axis perpendicular to the longitudinal direction of the arm 18. In the rotation portion 22, the swivel hinge 220 is disposed closer to the arm 18 and the tilt hinge 222 is disposed closer to the radiation generating unit 20.

The swivel hinge 220 allows the radiation generating unit 20 to rotate in a predetermined direction (F direction). The radiation generating unit 20 can be rotated within the range from at least −90° to +90° with respect to the position of the radiation generating unit 20 at which the radiation generating unit 20 emits radiation in the direction toward the floor in the state where the arm 18 is horizontally disposed.

The tilt hinge 222 allows the radiation generating unit 20 to rotate in a predetermined direction (G direction). The rotation axis in the G direction, which is the rotation axis of the tilt hinge 222, is coaxial with the central axis of the arm 18. The rotation axis in the F direction, which is the rotation axis of the swivel hinge 220, is perpendicular to the rotation axis in the G direction, which is the rotation axis of the tilt hinge 222. By rotating the radiation generating unit 20 using the tilt hinge 222, the radiation generating unit 20 can be inclined up to an angle at which the radiation generating unit 20 emits radiation in the direction toward the floor regardless of the angle of the arm 18 with respect to the pillar 14.

When the position of the radiation generating unit 20 is changed from the position during imaging illustrated in FIG. 1 to the position during storage illustrated in FIG. 3, the radiation generating unit 20 is rotated using the swivel hinge 220 and the tilt hinge 222. Thus, the radiation generating unit 20 can be retracted between the pillar 14 and the base frame 50. When the radiation generating unit 20 is retracted by folding the arm 18, the radiation generating unit 20 emits radiation in the horizontal direction.

The swivel hinge 220 and the tilt hinge 222 are independently operable. The swivel hinge 220 and the tilt hinge 222 may be torque hinges that can appropriately hold the position of the radiation generating unit 20. For example, a torque hinge exerting a small torque and having a lock mechanism that can fix the radiation generating unit 20 at an appropriate open angle or a combination of damper hinges may be usable. A lock mechanism that can fix the radiation generating unit 20 in a desired position may be additionally provided.

The radiation generating unit 20 includes guide portions 42 and 44, which are complementary members for keeping the distance between the radiation generating unit 20 and the object. The operator can move the radiation generating unit 20 to a desired position by raising or pulling the guide portion 42 or 44 while gripping the guide portion 42 or 44.

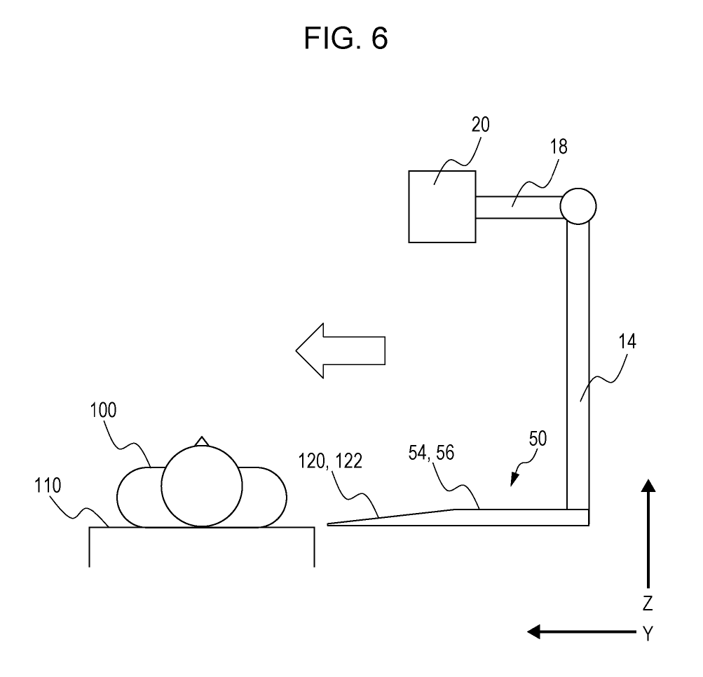

Referring now to FIGS. 6 to 9, the form of installation and the form of imaging of the radiation generating apparatus according to the embodiment will be described.

FIG. 6 illustrates a form of installation of the radiation generating apparatus over an object 100. The object 100 lies on a bed 110. The form illustrated in FIG. 6 is a form in which the radiation generating apparatus is moved in the Y direction toward the object 100.

As illustrated in FIG. 6, the second leg portion 54 and the third leg portion 56 of the base frame 50 have slopes 120 and 122, respectively. As described above, the slopes 120 and 122 are inclined surfaces on the tapered end sections of the second leg portion 54 and the third leg portion 56 of the base frame 50. Although the base frame 50 is designed to be disposed between the object 100 and the bed 110, it is difficult to secure a space sufficiently large to allow the base frame 50 to be smoothly disposed between the lying object 100 and the bed 110.

In this embodiment, the second leg portion 54 and the third leg portion 56 of the base frame 50 respectively have the slopes 120 and 122 on their tapered end sections so that the base frame 50 can be smoothly installed in a narrow space. Thus, the second leg portion 54 and the third leg portion 56 of the base frame 50 can be slid under the object 100 (the back side of the object 100). Since the end sections of the second leg portion 54 and the third leg portion 56 of the base frame 50 are tapered and thin, the radiation generating apparatus can be smoothly installed in a narrow space between the object 100 and the bed 110.

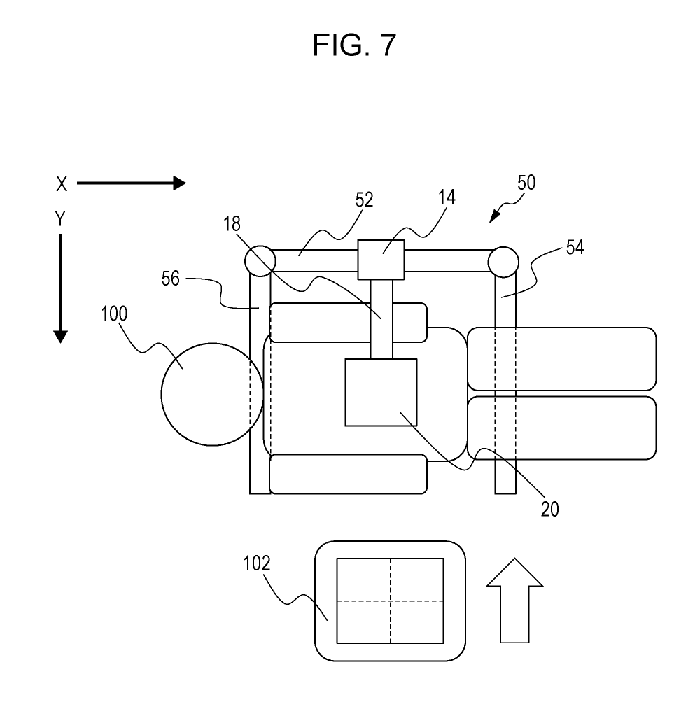

FIG. 7 illustrates the radiation generating apparatus in a plan view (when viewed from directly above). As illustrated in FIG. 7, the object 100 is lying in the X direction. During imaging, the base frame 50 is disposed under the back of the object 100 (on the bed). Specifically, the object 100 is lying across the second leg portion 54 and the third leg portion 56. The second leg portion 54 and the third leg portion 56 are respectively disposed under the neck of the object 100 and under portions of the legs below the buttocks. The distance between the second leg portion 54 and the third leg portion 56 is determined to be a predetermined distance (for example, 70 cm) or larger regardless of the size of the object 100 so that the second leg portion 54 and the third leg portion 56 are disposed under the neck of the object 100 and under portions of the legs below the buttocks. In this manner, the distance between the second leg portion 54 and the third leg portion 56 is determined in advance so that the device does not touch a predetermined portion of the object 100 (for example, the trunk). The distance between the second leg portion 54 and the third leg portion 56 is substantially the same as the length of the first leg portion 52. In other words, the distance between the second leg portion 54 and the third leg portion 56 is determined in advance by the length of the first leg portion 52.

The distance between the second leg portion 54 and the third leg portion 56 is determined so that the radiation generating apparatus can be finely balanced. The distance between the second leg portion 54 and the third leg portion 56 is also determined so as to facilitate installation of a detecting device 102 that detects, after the radiation generating unit 20 emits radiation to the object 100, radiation that has passed through the object 100 and converts the radiation into an image.

By disposing the second leg portion 54 and the third leg portion 56 at positions away from the trunk loaded with the weight of the object 100 the most, the second leg portion 54 and the third leg portion 56, or the base frame 50 can be easily installed. In other words, the radiation generating apparatus can be appropriately installed, thereby improving the working efficiency.

Now, a configuration of the detecting device 102 and the radiation generating apparatus will be described. An operator places the detecting device 102 between the second leg portion 54 and the third leg portion 56. For example, the operator inserts the detecting device 102 into an open space between the second leg portion 54 and the third leg portion 56 in the Y direction. The detecting device 102 disposed between the second leg portion 54 and the third leg portion 56 can image the trunk of the object 100.

This existence of the space for the detecting device 102 between the second leg portion 54 and the third leg portion 56 enables installation of the detecting device 102 on the back of the object 100 after the installation of the radiation generating apparatus and immediately before imaging. In addition, the detecting device 102 alone can be smoothly removed immediately after the imaging.

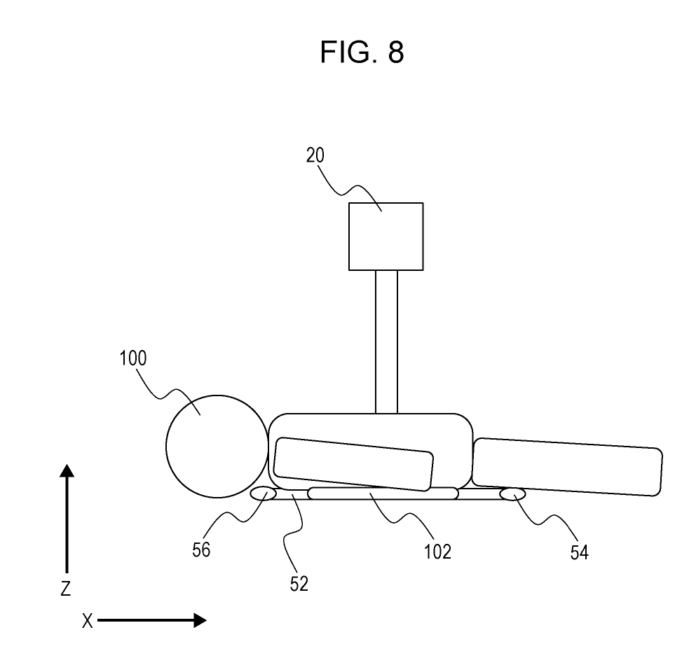

FIG. 8 is a side view of the radiation generating apparatus viewed from the free end side of the second leg portion 54 and the third leg portion 56. The thickness of the second leg portion 54 and the third leg portion 56 is substantially equal to the thickness of the detecting device 102. When the thickness of the second leg portion 54 and the third leg portion 56 is substantially equal to the thickness of the detecting device 102, the second leg portion 54, the third leg portion 56, and the detecting device 102 are leveled. This configuration can reduce discomfort or pain that is caused to the object 100.

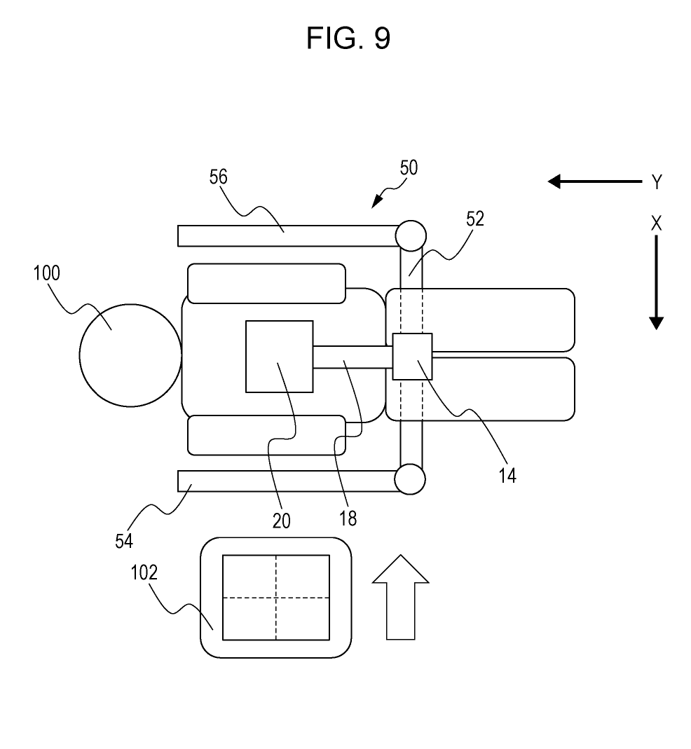

FIG. 9 illustrates another configuration of the radiation generating apparatus for imaging the object 100. In this configuration, the direction in which the radiation generating apparatus is installed with respect to the object 100 is substantially perpendicular to the direction in which the radiation generating apparatus is installed as in FIG. 7 with respect to the object 100, so that the applicable range of the invention broadens. As illustrated in FIG. 9, the base frame 50 is disposed on both sides of the lying object 100 and the pillar 14 is interposed between the legs of the object 100 and protrudes upright from between the legs.

Specifically, during imaging, the object 100 lies parallel to the longitudinal direction (Y direction) of the second leg portion 54 and the third leg portion 56. The distance between the second leg portion 54 and the third leg portion 56 is such that the object 100 can lie without touching the second leg portion 54 and the third leg portion 56. For example, the distance between the second leg portion 54 and the third leg portion 56 is larger or equal to the breadth of the shoulders of the object 100.

In addition, the pillar 14 has such a thickness that the object 100 can sandwich the pillar 14 between his/her thighs. The pillar 14 is, for example, a prism having a rectangular cross section whose sides are 10 cm or smaller.

In this manner, the radiation generating unit 20 can be installed directly above the object 100. Here, the base frame 50 (the second leg portion 54 and the third leg portion 56) can be prevented from touching the trunk of the object 100. Thus, as in the configuration illustrated in FIG. 7, the base frame 50 can be disposed at a position away from the trunk loaded with the weight of the object 100 the most. The radiation generating apparatus can thus be appropriately installed, thereby improving the working efficiency.

In addition, since the pillar 14 is disposed between the legs of the object 100 so as to stand upright from between the legs, the pillar 14 is kept out of reach of the object 100. Since there are many mentally confused objects 100 at home care or elderly care facilities, such objects 100 may unconsciously grip or pull an object within their reach. By keeping the pillar 14 out of reach of the objects 100, the pillar 14 can be prevented from being gripped or pulled by the objects 100.

The detecting device 102 is a device that detects, when radiation generating unit 20 emits radiation to the object 100, radiation that has passed through the object 100 and converts the radiation into an image. Since the base frame 50 has a thin-board structure, the detecting device 102 can be installed on the back of the object 100 after the installation of the radiation generating apparatus and immediately before imaging. The thin-board structure of the base frame 50 here means a structure in which the base frame 50 is thinner than the detecting device 102. The thin-board structure of the base frame 50 enables smooth removal of the detecting device 102 alone immediately after imaging.

As described above, the radiation generating apparatus according to the embodiment includes a support structure, which supports the radiation generating unit that generates radiation, and the base frame 50 that supports the support structure and includes multiple leg portions disposed at a predetermined interval.

When the support structure is regarded as including the arm 18 and the pillar 14 supporting the arm 18, the radiation generating apparatus according to the embodiment includes the base frame 50 that supports the pillar 14 and includes multiple leg portions disposed at a predetermined interval.

Thus, the radiation generating apparatus according to the embodiment is portable and enables easy installation of the radiation generating unit in accordance with the target position of the object.

Objects 100 at home care or elderly care facilities are more likely to be elderly people having difficulty in lying on their back on a bed. The reduction of time for installing the detecting device 102 can reduce discomfort or pain that is caused to the objects 100. Second Embodiment

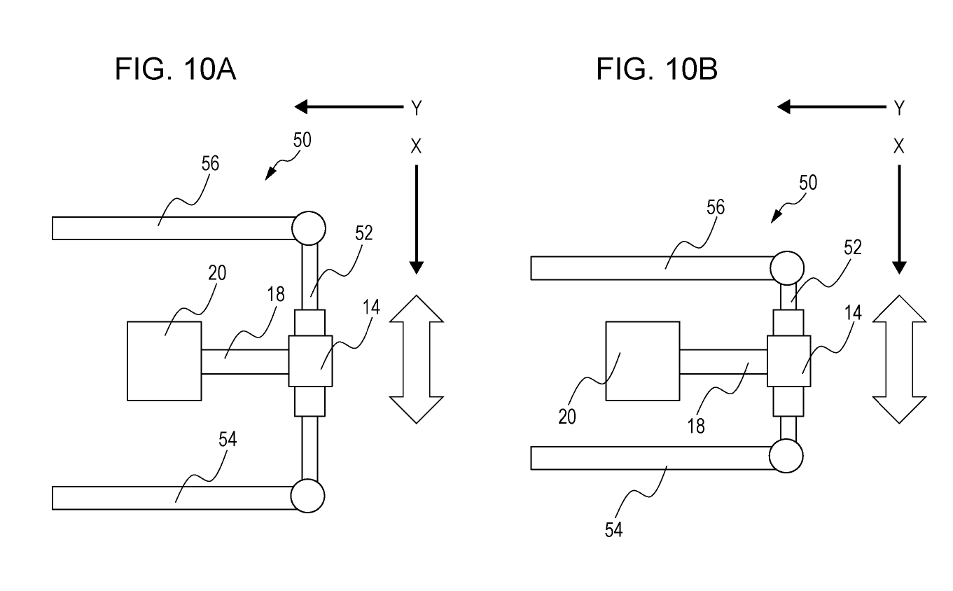

FIGS. 10A and 10B illustrate a radiation generating apparatus according to a second embodiment. The radiation generating apparatus according to the second embodiment is different from the device according to the first embodiment in such terms that the base frame 50 has an adjustment mechanism that adjusts the distance between multiple leg portions.

FIGS. 10A and 10B illustrate a radiation generating apparatus in which the distance between multiple leg portions is adjustable. A first leg portion 52 is a base portion connecting the other leg portions (a second leg portion 54 and a third leg portion 56) so as to form a C shape or a U shape.

Here, the first leg portion 52 that connects the second leg portion 54 and the third leg portion 56 together has an adjustment mechanism, not illustrated, for extending and shortening the first leg portion 52. Thus, the length of the first leg portion 52 is adjustable by the adjustment mechanism for extending and shortening the first leg portion 52. Specifically, the adjustment mechanism for extending and shortening the first leg portion 52 includes two or more components and has, for example, a nesting structure. The nestable components of the first leg portion 52 enable extension or shortening of the first leg portion 52. Extension or shortening of the first leg portion 52 that connects the second leg portion 54 and the third leg portion 56 together enables adjustment of the distance between the second leg portion 54 and the third leg portion 56.

By extending the first leg portion 52 using the adjustment mechanism, as illustrated in FIG. 10A, the distance between the second leg portion 54 and the third leg portion 56 can be increased. By shortening the first leg portion 52 using the adjustment mechanism, as illustrated in FIG. 10B, the distance between the second leg portion 54 and the third leg portion 56 can be reduced.

Thus, the base frame 50 having the above mechanism can be widely used for various types of objects 100 including tall, short, stout, and thin objects.

The adjustment mechanism of the base frame 50 may be marked with several levels. When the adjustment mechanism is marked with several levels for, for example, tall and short objects, stout and thin objects, or male and female objects to facilitate adjustment to a predetermined distance, the radiation generating apparatus can be more smoothly installed.

Depending on the position of the imaging target, the length of the multiple base frames (the second leg portion 54 and the third leg portion 56) may be adjusted. Here, the adjustment mechanism is similar to that of the first leg portion 52. In the case where the radiation generating unit 20 has to be moved to a position distant from the pillar 14 to image a target portion, the length of the multiple base frame portions is adjusted. Specifically, the length of the second leg portion 54 and the third leg portion 56 is increased. Thus, the radiation generating unit 20 can be moved to an appropriate position while the radiation generating apparatus is finely balanced. Third Embodiment

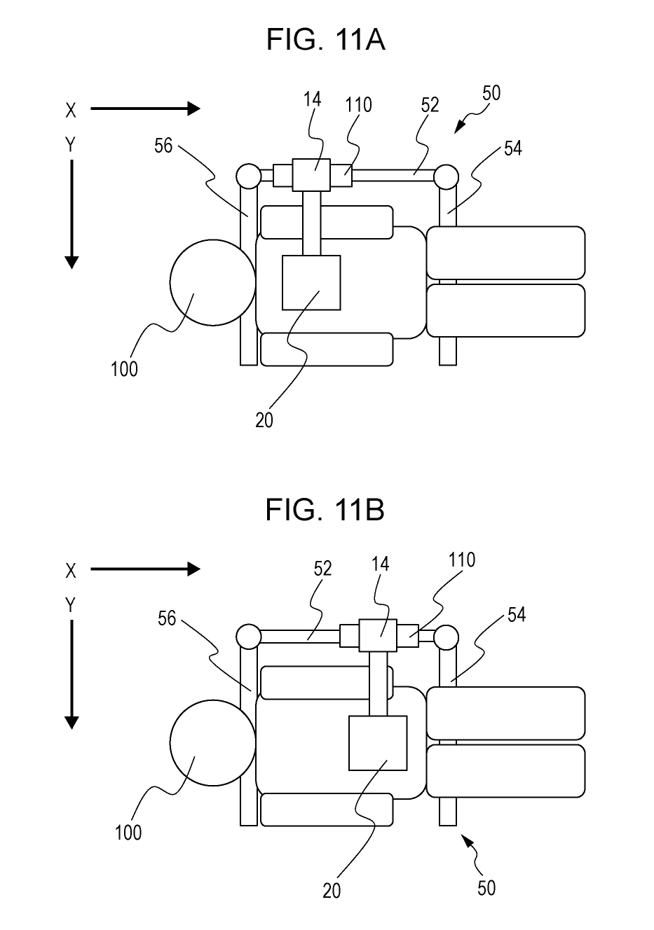

FIGS. 11A and 11B illustrate a radiation generating apparatus according to a third embodiment. The device according to the third embodiment is different from those according to the first and second embodiments in such terms that the base frame 50 has a moving mechanism 110 that moves the pillar 14 in the horizontal direction (X direction).

The first leg portion 52 is coupled to the pillar 14. For example, the first leg portion 52 includes the coupling portion 62 used for coupling the pillar 14, as illustrated in FIG. 2. The first leg portion 52 includes a moving mechanism 110 that can move the coupling portion 62 in the longitudinal direction of the first leg portion 52 (X direction). As an example of the moving mechanism 110, the first leg portion 52 includes a slidable portion, not illustrated, so as to extend in the longitudinal direction of the first leg portion 52 (X direction). The slidable portion allows the coupling portion 62 to slide. When the slidable portion causes the coupling portion 62 coupled with the pillar 14 to slide, the pillar 14 can be moved in the horizontal direction (X direction). Since the coupling portion 62 coupled with the pillar 14 can move in the longitudinal direction of the first leg portion 52 (X direction), the radiation generating unit 20 can also slide in the X direction.

This configuration increases the movable range of the radiation generating unit 20, and thus the radiation generating unit 20 can be easily moved to a position appropriate for the target position of the object 100 without the need of moving the base frame 50.

A radiographic system according to an embodiment includes a radiation generating apparatus, a detecting device that detects radiation generated by the radiation generating unit and having passed through an object and that outputs image data according to the radiation, and a display device that displays images, although the display device is not illustrated.

Here, besides α-rays, β-rays, γ-rays, and X-rays, which are beams of particles (including photons) emitted as a result of radioactive decay, radiation includes beams having an equivalent energy, such as corpuscular beams and cosmic rays.

Although the arm 18 and the pillar 14 of the radiographic system according to the embodiment of the invention are separately described, this configuration is not limitative. Besides the arm 18 and the pillar 14, a single support structure having functions of the arm 18 and the pillar 14 is also usable. Such a support structure is a member that can couple the radiation generating unit 20 and the base frame 50 together and support the radiation generating unit 20. For example, the support structure has a bellows structure having a predetermined rigidity and is foldable to retract the radiation generating unit 20.

The radiation generating unit 20 is a transmission radiation generating unit. In order to block unnecessary radiation, the transmission radiation generating unit includes radiation shielding members on the side from which electrons of the target enter and on the side from which the radiation is emitted. The transmission radiation generating unit does not require shielding of a radiation generating tube or the entire periphery of the envelop containing the radiation generating tube with a barrier made of lead or other materials. Thus, the transmission radiation generating unit can be sized smaller than, for example, a rotation-anode radiation generating unit.

The small lightweight radiation generating unit 20 dispenses with a heavy support. Thus, the radiation generating apparatus can be finely balanced with the use of the base frame 50 including multiple leg portions disposed at a predetermined interval.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-073015, filed Mar. 29, 2013, which is hereby incorporated by reference herein in its entirety.

What is claimed is:

1. A radiation generating apparatus, comprising:
a support structure that supports a radiation generating unit that generates radiation; and
a base frame that supports the support structure and includes a plurality of leg portions.

2. The radiation generating apparatus according to claim 1, wherein the plurality of leg portions are configured to be arranged in a C-shaped or U-shaped manner.

3. The radiation generating apparatus according to claim 1, wherein the base frame includes a first leg portion coupled with a pillar, a second leg portion coupled with one end of the first leg portion, and a third leg portion coupled with another end of the first leg portion.

4. The radiation generating apparatus according to claim 3, wherein the base frame includes a joint that adjusts an angle between the first leg portion and the second leg portion and a joint that adjusts an angle between the first leg portion and the third leg portion.

5. The radiation generating apparatus according to claim 4, wherein an angle between the first leg portion and the second leg portion in the imaging state is larger than an angle between the first leg portion and the second leg portion in the storage state and an angle between the first leg portion and the third leg portion in the imaging state is larger than an angle between the first leg portion and the third leg portion in the storage state.

6. The radiation generating apparatus according to claim 5, wherein, in the imaging state, the second leg portion and the third leg portion are disposed perpendicular to the first leg portion.

7. The radiation generating apparatus according to claim 4, wherein the second leg portion and the third leg portion are configured to be folded, and wherein, when the second leg portion and the third leg portion have been folded, the second leg portion and the third leg portion are parallel to the first leg portion.

8. The radiation generating apparatus according to claim 3, wherein each of the second leg portion and the third leg portion has a slope at an end section thereof.

9. The radiation generating apparatus according to claim 3, wherein the second leg portion is straight and the third leg portion is L-shaped.

10. The radiation generating apparatus according to claim 3, wherein the base frame includes a first fitting portion with which the first leg portion and the second leg portion are fitted to each other and a second fitting portion with which the first leg portion and the third leg portion are fitted to each other.

11. The radiation generating apparatus according to claim 1, wherein the base frame includes a coupling portion with which the base frame is removably coupled with the support structure.

12. The radiation generating apparatus according to claim 1, wherein the base frame includes an adjustment mechanism that adjusts a distance between the plurality of leg portions.

13. The radiation generating apparatus according to claim 1, wherein the base frame includes a moving mechanism that moves the support structure in the horizontal direction.

14. The radiation generating apparatus according to claim 1, further comprising a power supply unit that supplies electrical power to the radiation generating unit, wherein the power supply unit is arranged on the support structure above the base frame.

15. The radiation generating apparatus according to claim 14, wherein the power supply unit is disposed on the support structure at a side opposite to a side on which the radiation generating unit is disposed.

16. A radiographic system, comprising:
the radiation generating apparatus according to claim 1;
a detecting device that detects radiation transmitted through an object and outputs image data according to the detected radiation; and
a display device that displays an image based on the image data.

17. The radiographic system according to claim 16, wherein the detecting device is disposed above the base frame between the second leg portion and the third leg portion.
